(19) United States
(12) Patent Application Publication
(10) Pub. No.: US 2026/0269454 A1
(43) Pub. Date: Sep. 10, 2026

(54) ANTENNA POLE, POSITIONING SYSTEM, AND YARD WORKING SYSTEM

(71) Applicant: SHENZHEN HANYANG TECHNOLOGY CO., LTD., Shenzhen (CN)

(72) Inventors: Yang HUANG, Shenzhen (CN); Taotao ZHU, Shenzhen (CN); Yongqi SONG, Shenzhen (CN)

(21) Appl. No.: 19/664,933

(22) Filed: Apr. 30, 2026

Related U.S. Application Data
(63) Continuation of application No. PCT/CN2023/132670, filed on Nov. 20, 2023.

(30) Foreign Application Priority Data
Jul. 5, 2023 (CN) 202321755595.2
Jul. 5, 2023 (CN) 202321760903.0

(51) Int. Cl. H01Q 1/12; E01H 5/09; F16B 7/04

(52) U.S. Cl. CPC H01Q 1/1242; F16B 7/042; E01H 5/096

(57) ABSTRACT

An antenna pole, a positioning system, and a yard working system are provided. The antenna pole includes a pole body and a rotation assembly. The rotation assembly includes an antenna mount and a pole connector, and the antenna mount is pivotally connected to the pole connector. The pole body includes a plurality of antenna mounting tubes and a connector. The connector includes a plurality of connecting through-tubes extending respectively in a first direction, a second direction, and a third direction and in communication with each other. The first direction is opposite to the second direction, and the third direction is at an angle with the first direction. At least one of the antenna mounting tubes is connected between the pole connector and a first connecting through-tube, and at least another one of the antenna mounting tubes is connected to a second connecting through-tube.

### CROSS-REFERENCE TO RELATED APPLICATIONS

This patent document claims priority to and the benefits of PCT Application No. PCT/CN 2023/132670 filed on Nov. 20, 2023, which further claims priority to and the benefits of Chinese Patent Application Nos. 202321755595.2 and 202321760903.0 both filed on Jul. 5, 2023, the contents of each of which are hereby incorporated by reference.

### TECHNICAL FIELD

The present disclosure relates to the technical field of antennas, and in particular to an antenna pole, a positioning system, and a yard working system.

### BACKGROUND

Conventionally, an antenna pole may be used to elevate an antenna, thereby facilitating signal transmission and reception by the antenna. However, traditional antenna poles are generally straight poles, making it difficult to adjust their angles, and thus failing to satisfy user needs.

### SUMMARY

Embodiments of the present disclosure provide an antenna pole, a positioning system, and a yard working system to alleviate at least one of the above-mentioned problems.

Embodiments of the present disclosure achieve the above objective through the following technical solutions.

In a first aspect, an embodiment of the present disclosure provides an antenna pole. The antenna pole comprises a pole body and a rotation assembly. The rotation assembly comprises an antenna mount and a pole connector, and the antenna mount is pivotally connected to the pole connector. The pole body comprises a plurality of antenna mounting tubes and a connector. The connector comprises a plurality of connecting through-tubes extending respectively in a first direction, a second direction, and a third direction and in communication with each other. The first direction is opposite to the second direction, and the third direction is at an angle with the first direction. At least one of the antenna mounting tubes is connected between the pole connector and one of the connecting through-tubes of the connector, and at least another one of the antenna mounting tubes is connected to another one of the connecting through-tubes.

In a second aspect, an embodiment of the present disclosure further provides a positioning system. The positioning system comprises a reference station antenna, a positioning base station, and an antenna pole. The antenna pole comprises a pole body and a rotation assembly. The rotation assembly comprises an antenna mount and a pole connector, and the antenna mount is pivotally connected to the pole connector. The pole body comprises a plurality of antenna mounting tubes and a connector. The connector comprises connecting through-tubes extending respectively in a first direction, a second direction, and a third direction and in communication with each other. The first direction is opposite to the second direction, and the third direction is at an angle with the first direction. At least one of the antenna mounting tubes is connected between the pole connector and one of the connecting through-tubes of the connector, and at least another one of the antenna mounting tubes is connected to another one of the connecting through-tubes. The reference station antenna is mounted on the antenna pole, and the positioning base station is communicatively connected to the reference station antenna.

In a third aspect, an embodiment of the present disclosure further provides a yard working system. The yard working system comprises an autonomous working device and a positioning system. The positioning system comprises a reference station antenna, a positioning base station, and an antenna pole. The antenna pole comprises a pole body and a rotation assembly. The rotation assembly comprises an antenna mount and a pole connector, and the antenna mount is pivotally connected to the pole connector. The pole body comprises a plurality of antenna mounting tubes and a connector. The connector comprises connecting through-tubes extending respectively in a first direction, a second direction, and a third direction and in communication with each other. The first direction is opposite to the second direction, and the third direction is at an angle with the first direction. At least one of the antenna mounting tubes is connected between the pole connector and one of the connecting through-tubes of the connector, and at least another one of the antenna mounting tubes is connected to another one of the connecting through-tubes. The reference station antenna is mounted on the antenna pole, and the positioning base station is communicatively connected to the reference station antenna. The autonomous working device is provided with a mobile station antenna, and the mobile station antenna is communicatively connected to the positioning base station.

### BRIEF DESCRIPTION OF THE DRAWINGS

To more clearly illustrate the technical solutions in the embodiments of the present disclosure, the accompanying drawings used in the description of the embodiments will be briefly introduced below. Obviously, the accompanying drawings in the following descriptions are merely illustrative of some embodiments of the present disclosure, and those skilled in the art may derive other drawings from these accompanying drawings without creative efforts.

FIG. 1 is a schematic structural diagram of an antenna pole according to an embodiment of the present disclosure;

FIG. 2 is a schematic structural diagram of a rotation assembly in FIG. 1;

FIG. 3 is a schematic exploded view of the rotation assembly in FIG. 2;

FIG. 4 is a schematic structural diagram of an antenna mounting tube in FIG. 1;

FIG. 5 is a schematic structural diagram of an elastic positioning component in FIG. 3;

FIG. 6 is a schematic cross-sectional view of the elastic positioning component in FIG. 5;

FIG. 7 is a schematic structural diagram of a connector in FIG. 1;

FIG. 8 is a schematic structural diagram of an antenna mounting tube in FIG. 1 according to another embodiment;

FIG. 9 is a schematic structural diagram of an antenna mounting tube in FIG. 1 according to yet another embodiment;

FIG. 10 is a schematic structural diagram of a base in FIG. 1;

FIG. 11 is a schematic structural diagram of an antenna pole according to another embodiment of the present disclosure;

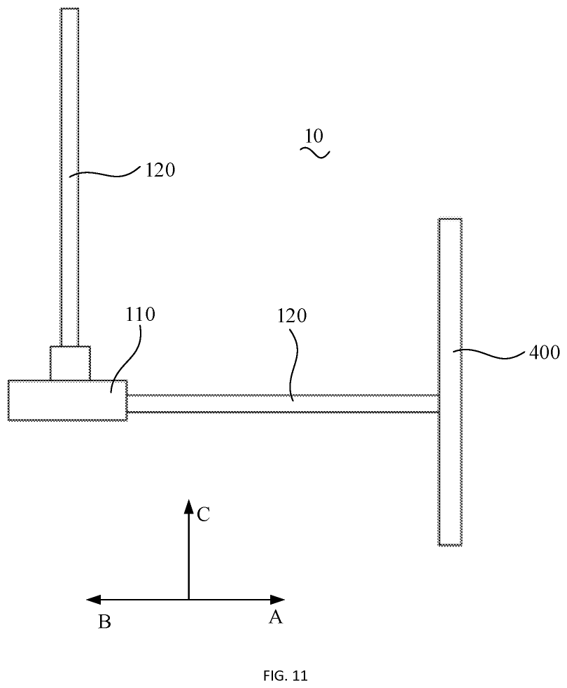

FIG. 12 is a schematic structural diagram of a yard working system according to an embodiment of the present disclosure; and

FIG. 13 is a schematic structural diagram of an autonomous working device in FIG. 12.

### REFERENCE NUMERALS

antenna pole 10, pole body 100, second insertion portion 101, second through hole 101a, connector 110, connecting through-tube 111, third insertion portion 112, third through hole 113, wire channel 114, wire passage notch 115, side wall 116, antenna mounting tube 120, fourth insertion portion 121, fourth through hole 122, sixth insertion portion 123, sixth through hole 124, rotation assembly 200, antenna mount 210, pole connector 220, first side wall 221, positioning hole 221a, second side wall 222, through hole 222a, first insertion portion 223, first through hole 223a, elongated slot 223, positioning section 224, transition section 225, elastic positioning component 230, positioning ball 231, limiting sleeve 232, limiting space 232a, opening 232b, compression spring 233, locking component 240, signal wire 300, wall 400, base 500, fifth insertion portion 510, fifth through hole 511, yard working system 20, positioning system 30, reference station antenna 610, positioning base station 620, autonomous working device 700, mobile station antenna 710, snow removal device 720, self-propelled device 730, controller 731, drive component 732, first direction A, second direction B, and third direction C.

### DETAILED DESCRIPTION

To enable those skilled in the art to better understand the solutions of the present disclosure, the technical solutions in embodiments of the present disclosure will be clearly and comprehensively described below in conjunction with the accompanying drawings in the embodiments of the present disclosure. Apparently, the embodiments described are merely some embodiments rather than all embodiments of the present disclosure. All other embodiments derived by those skilled in the art based on the embodiments of the present disclosure without creative efforts fall within the scope of protection of the present disclosure.

The technical solutions in the embodiments of the present disclosure are clearly and completely described below with reference to the accompanying drawings in the embodiments of the present disclosure.

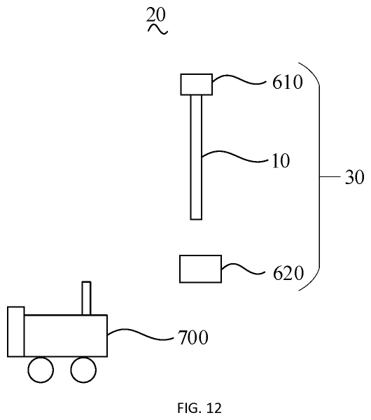

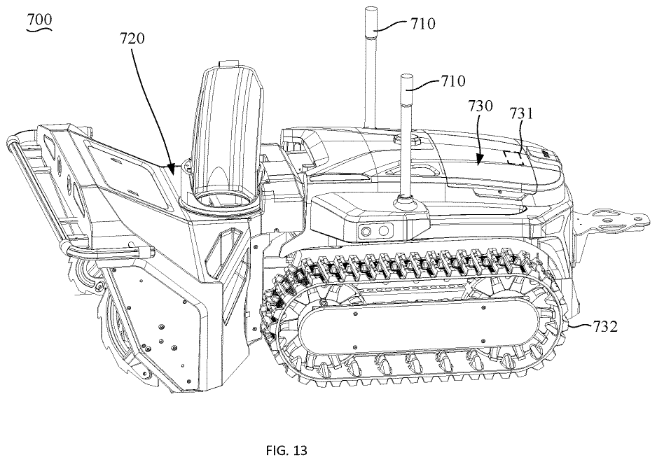

With reference to FIG. 12 and FIG. 13, a yard working system 20 is provided in the embodiments of the present disclosure. The yard working system 20 may include a positioning system 30 and an autonomous working device 700. The autonomous working device 700 and the positioning system 30 may be positioned through real-time kinematic (RTK) technology. Thus, the autonomous working device 700 may be accurately positioned, facilitating the operation of the autonomous working device 700.

With reference to FIG. 13, the autonomous working device 700 may be provided with a mobile station antenna 710, where the mobile station antenna 710 may receive satellite signals to acquire a global position of the autonomous working device 700. The mobile station antenna 710 may also be communicatively connected to a positioning base station 620. Thus, the autonomous working device 700 may correct a real-time position through the positioning base station 620 to facilitate the operation of the autonomous working device 700. The autonomous working device 700 may be an automatic snow removal device, an automatic leaf blower, an automatic weeder, or the like. Reference is made to the following embodiments for a specific structure of the positioning system 30. The yard working system 20 employs the technical solutions in the embodiments described below, and thus provides the beneficial effects brought by the technical solutions in the embodiments described below, which will not be repeated herein.

In the following embodiments, the autonomous working device 700 being an automatic snow removal device is described as an example, though other embodiments may be implemented.

The automatic snow removal device may include a snow removal device 720 and a self-propelled device 730, where the self-propelled device 730 may be connected to the snow removal device 720 to carry the snow removal device 720 during movement. The self-propelled device 730 may include a controller 731 and a drive component 732, where the controller 731 may include a circuit board or the like, and the controller 731 may control the drive component 732 to move. The drive component 732 may be configured to drive the snow removal device 720 to move. For example, the drive component 732 may include a plurality of driving wheels, and the plurality of driving wheels may be arranged at a bottom of the self-propelled device 730, so that the self-propelled device 730 drives the snow removal device 720 to move.

The autonomous working device 700 may include an ultrasonic ranging sensor. The autonomous working device 700 may have a path planning function (i.e., an obstacle handling capability). The autonomous working device 700 may automatically cross small obstacles, avoid medium and large obstacles in time, and remove snow around the obstacles to a maximum extent. A transmitter of the ultrasonic ranging sensor of the autonomous working device 700 may emit ultrasonic waves, and the ultrasonic waves are reflected after encountering an obstacle. A receiver of the ultrasonic ranging sensor may measure a distance from the obstacle to the autonomous working device 700 according to a time difference of receiving the reflected ultrasonic waves. Thus, the autonomous working device 700 may plan to avoid the obstacle in advance and avoid a collision, effectively improving safety performance. Certainly, in other embodiments, the autonomous working device 700 may alternatively avoid obstacles using an infrared ranging sensor or a laser ranging sensor.

The autonomous working device 700 may be further provided with a signal processing unit. For example, the signal processing unit may be the controller 731, and the signal processing unit may process a signal sent by the positioning system 30 and received by the mobile station antenna 710 to acquire a relatively accurate real-time position, thereby assisting the automatic snow removal device in operating along a preset path.

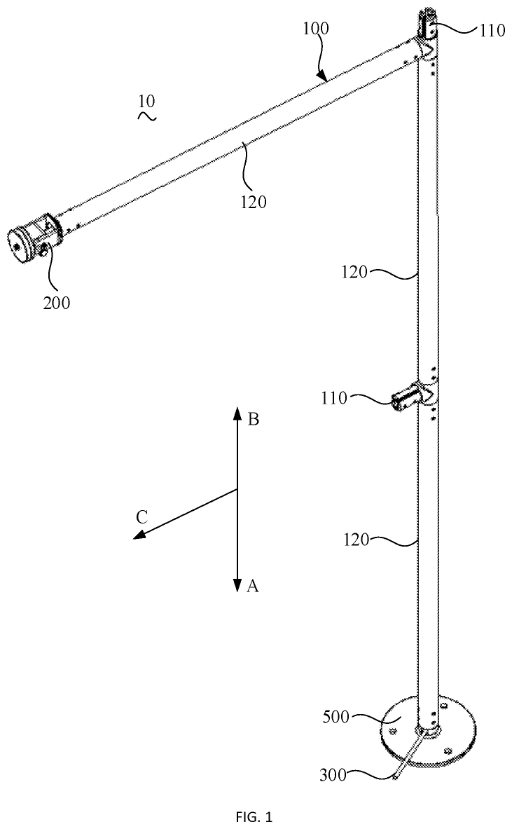

With reference to FIG. 1, the positioning system 30 is further provided in the embodiments of the present disclosure. The positioning system 30 may include an antenna pole 10, a reference station antenna 610, and a positioning base station 620. The reference station antenna 610 may be mounted on the antenna pole 10, so that the antenna may be lifted or an angle of the antenna may be adjusted. The positioning base station 620 may be communicatively connected to the reference station antenna 610, so that the positioning base station 620 may receive satellite signals to acquire a global position of the reference station antenna 610. Reference is made to the following embodiments for a specific structure of the antenna pole. The positioning system 30 employs all the technical solutions in all the implementations described below, and thus has at least all the beneficial effects brought by the technical solutions in the implementations described below, which will not be repeated herein.

Understandably, the reference station antenna 610 may receive satellite signals to acquire its own position information. The positioning base station 620 may send the position information of the reference station antenna 610 to the autonomous working device 700. The autonomous working device 700 may acquire its own position information through the mobile station antenna 710. The autonomous working device 700 may perform a differential correction on its own position information after acquiring the position information of the reference station antenna 610, which assists the autonomous working device 700 in acquiring an accurate real-time position.

In some embodiments, the reference station antenna 610 may be electrically connected to the positioning base station 620. For example, the reference station antenna 610 may be electrically connected to the positioning base station 620 via a signal wire 300. The signal wire 300 may be a subminiature version A (SMA) wire, and part of the signal wire 300 may be arranged within the antenna pole 10, so that the antenna pole 10 protects the signal wire 300. The reference station antenna 610 may be mounted at a distal end of the antenna pole 10, such that the antenna pole 10 may elevate the reference station antenna 610 or adjust the angle thereof.

In some embodiments, the positioning base station 620 may be arranged indoors, and the reference station antenna 610 may be arranged outdoors via the antenna pole 10, thereby reducing the weight of the object to be supported by the antenna pole 10.

For ease of description, the antenna referred to below corresponds to the reference station antenna 610 described above.

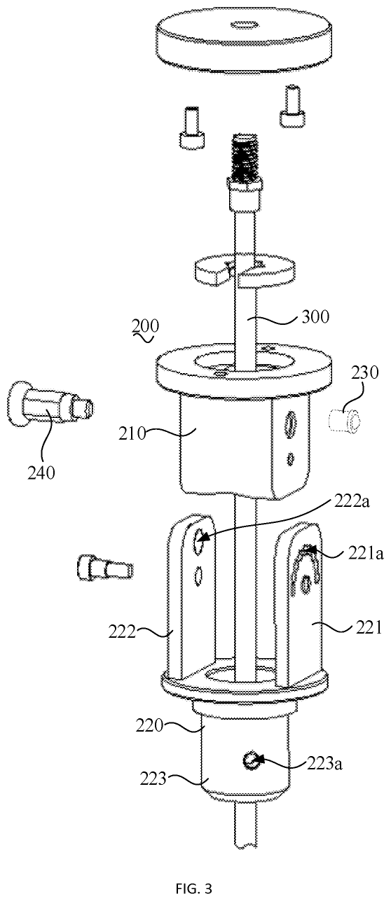

With reference to FIG. 1 through FIG. 3 and FIG. 7, the antenna pole 10 is further provided in the embodiments of the present disclosure. The antenna pole 10 may include a pole body 100 and a rotation assembly 200. The rotation assembly 200 includes an antenna mount 210 and a pole connector 220, and the antenna mount 210 is pivotally connected to the pole connector 220. The pole body 100 includes a plurality of antenna mounting tubes 120 and a connector 110. The connector 110 includes connecting through-tubes 111 extending respectively in a first direction A, a second direction B, and a third direction C and in communication with each other. The first direction A is opposite to the second direction B, and the third direction C is at an angle with the first direction A. At least one of the antenna mounting tubes 120 is connected between the pole connector 220 and a first connecting through-tube 111 of the connector 110, and at least another one of the antenna mounting tubes 120 is connected to a second connecting through-tube 111.

In this way, the antenna mount 210 may be pivotally connected to the pole connector 220, so that the antenna mount 210 may rotate relative to the pole connector 220 under the action of an external force, in order for the antenna mount 210 to drive the antenna mounted on the antenna mount 210 to rotate relative to the pole connector 220, which helps to adjust the angle of the antenna mounted on the antenna mount 210. Thus, the antenna pole 10 may not only elevate the antenna mounted on the antenna mount 210, but also change the angle of the antenna mounted on the antenna mount 210, thereby providing the antenna pole 10 with more functions and facilitating an improvement in the practicability of the antenna pole 10. The operation is convenient, the structure is simple, and it helps to satisfy the use demands of a user and improve user experience.

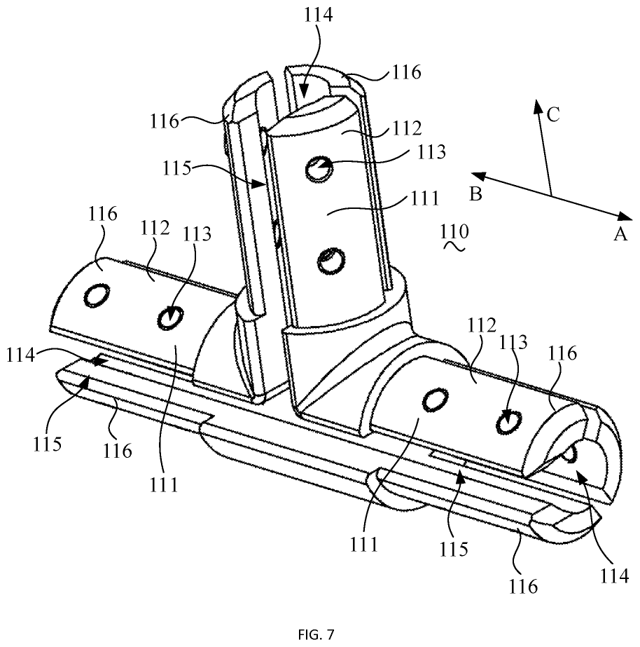

In addition, with reference to FIG. 1 and FIG. 7, the antenna pole 10 may be combined in different ways. For example, at least one of the antenna mounting tubes 120 may be connected to the connecting through-tube 111 extending in the first direction A, and at least another one of the antenna mounting tubes 120 may be connected to the connecting through-tube 111 extending in the second direction B. The plurality of antenna mounting tubes 120 may be spliced to adjust a length of the antenna pole 10. The pole connector 220 may be connected to an end, facing away from the connector 110, of one of the two antenna mounting tubes 120 described above. For another example, at least one of the antenna mounting tubes 120 may be connected to the connecting through-tube 111 extending in the first direction A or the second direction B, at least another one of the antenna mounting tubes 120 may be connected to the connecting through-tube 111 extending in the third direction C, and the pole connector 220 may be connected to an end, facing away from the connector 110, of one of the two antenna mounting tubes 120 described above. Thus, angles of two adjacent antenna mounting tubes 120 may be adjusted, and an angle of the antenna pole 10 is adjustable. The antenna pole 10 may employ different combination methods to adjust the length and the angle. Thus, the antenna pole 10 has more functions and improved practicability to satisfy the demand of the user, and is simple in structure and low in cost.

The connector 110 may include the connecting through-tube 111 extending in the first direction A, wherein a length direction of the connecting through-tube 111 extending in the first direction A is parallel to the first direction A. The connector 110 may further include the connecting through-tube 111 extending in the second direction B, wherein a length direction of the connecting through-tube 111 extending in the second direction B is parallel to the second direction B. The connector 110 may further include the connecting through-tube 111 extending in the third direction C, wherein a length direction of the connecting through-tube 111 extending in the third direction C is parallel to the third direction C. The connector 110 may further incorporate additional extending directions (e.g., a fourth, fifth, or sixth direction) based on actual requirements. The angle formed between the third direction C and the first direction A may be configured according to actual conditions.

There may be a plurality of ways to connect the antenna mounting tube 120 to the connecting through-tube 111. For example, the antenna mounting tube 120 may be connected to the connecting through-tube 111 through a threaded connection. For another example, the antenna mounting tube 120 may be connected to the connecting through-tube 111 through a screw connection. For yet another example, the antenna mounting tube 120 may be connected to the connecting through-tube 111 through a snap-fit buckle connection. The antenna mounting tube 120 may have a hollow cylindrical structure and may be manufactured using an aluminum tube, such that the antenna mounting tube 120 is light in weight and low in cost.

Understandably, the antenna mount 210 may be driven to rotate relative to the pole connector 220 in various ways. For example, an operator may manually drive the antenna mount 210, or a mechanical arm may drive the rotation.

There may be a plurality of ways to pivotally connect the antenna mount 210 to the pole connector 220. For example, the antenna mount 210 may be pivotally connected to the pole connector 220 via a pin or a screw. For another example, the antenna mount 210 may be pivotally connected to the pole connector 220 via a hinge.

In some embodiments, the pole connector 220 may comprise a first side wall 221 and a second side wall 222 protruding toward the antenna mount 210. The second side wall 222 may be opposite to and spaced apart from the first side wall 221, and the antenna mount 210 may be pivotally connected between the first side wall 221 and the second side wall 222. Specifically, there may be a plurality of ways to pivotally connect the antenna mount 210 to the first side wall 221 and the second side wall 222. For example, the antenna mount 210 may be pivotally connected to the first side wall 221 and the second side wall 222 via a pin or a screw; for another example, the antenna mount 210 may be pivotally connected to the first side wall 221 and the second side wall 222 via a hinge, such that the antenna mount 210 is pivotally connected between the first side wall 221 and the second side wall 222. In this way, the antenna mount 210 may pitch relative to the pole connector 220, so that an antenna mounted on the antenna mount 210 may pitch relative to the pole connector 220 along with the antenna mount 210, thereby helping a user to perform a pitching angular adjustment of the antenna mounted on the antenna mount 210.

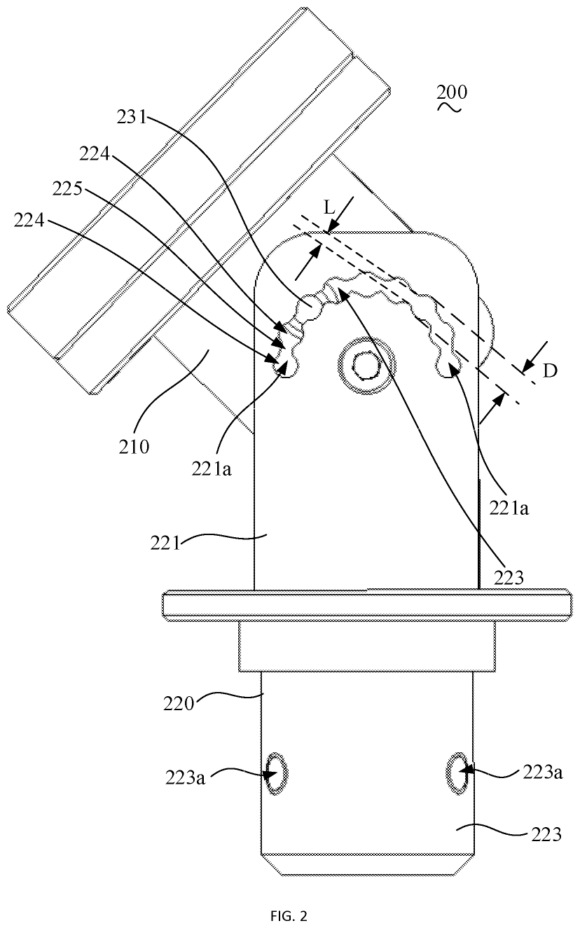

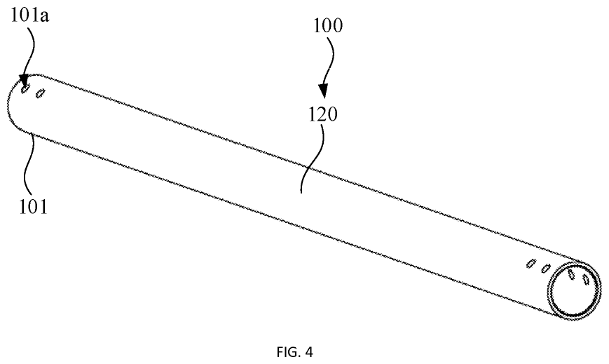

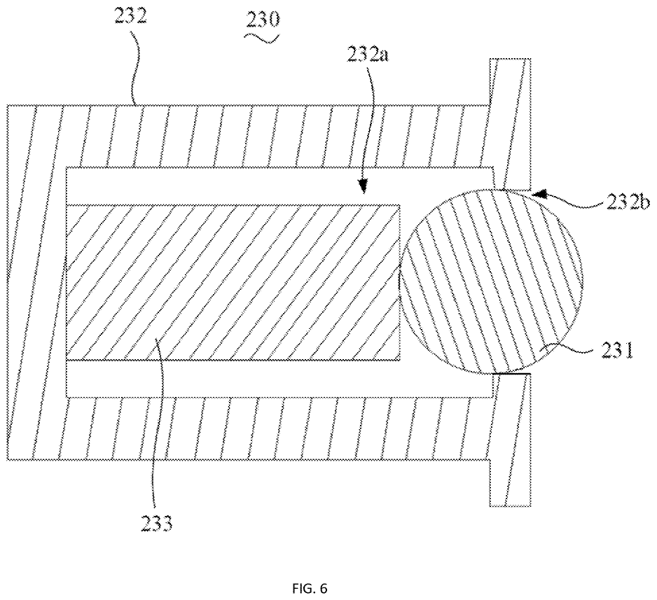

With reference to FIG. 2 through FIG. 6, in some embodiments, the rotation assembly 200 may further include an elastic positioning component 230. The elastic positioning component 230 may be connected to the antenna mount 210 and located between the antenna mount 210 and the first side wall 221. The elastic positioning component 230 may include a positioning ball 231, and the first side wall 221 may be provided with a plurality of positioning holes 221a matching the positioning ball 231. The positioning ball 231 may be configured to be selectively in a locked positioning state or an unlocked state. When the positioning ball 231 is in the locked positioning state, the positioning ball 231 may be partially located in the positioning hole 221a; when the positioning ball 231 is in the unlocked state, the positioning ball 231 may be disengaged from the positioning hole 221a.

When the positioning ball 231 is in the locked positioning state, the positioning ball 231 is partially located in the positioning hole 221a, which helps the positioning ball 231 to relatively lock the antenna mount 210 relative to the first side wall 221, thereby fixing the antenna mount 210 relative to the first side wall 221. This further helps an operator to debug whether the angle of the antenna mounted on the antenna mount 210 satisfies a use requirement, and subsequently also benefits the operator in fixing the antenna mount 210 relative to the pole connector 220.

When the positioning ball 231 is in the unlocked state and the positioning ball 231 is disengaged from the positioning hole 221a, it helps the positioning ball 231 to unlock the antenna mount 210 relative to the first side wall 221, such that the antenna mount 210 may move relative to the pole connector 220 under the action of an external force, which further helps the operator to adjust the angle of the antenna mounted on the antenna mount 210.

In some embodiments, the elastic positioning component 230 may further include a limiting sleeve 232 and a compression spring 233. The limiting sleeve 232 may define a limiting space 232a and an opening 232b, and the opening 232b may be in communication with the limiting space 232a. The compression spring 233 may be arranged in the limiting space 232a. A first part of the positioning ball 231 may be located in the limiting space 232a and abut against an end of the compression spring 233 facing the opening 232b, and a second part of the positioning ball 231 may protrude outside the opening 232b. Specifically, under the action of an external force, the positioning ball 231 may exert a force on the compression spring 233 along a direction from the opening 232b toward the limiting space 232a, causing the compression spring 233 to compress, so that the positioning ball 231 may move along the direction from the opening 232b toward the limiting space 232a, which helps the positioning ball 231 to disengage from the positioning hole 221a. In a case where the positioning ball 231 is not subjected to an external force or is subjected to a relatively small external force, the compression spring 233 will push the positioning ball 231 to move from the limiting space 232a toward the opening 232b due to the action of elastic deformation, so that the second part of the positioning ball 231 protrudes outside the opening 232b, which helps the positioning ball 231 to be partially located within the positioning hole 221a.

In this way, when the antenna mount 210 drives the positioning ball 231 to move to the positioning hole 221a, the positioning ball 231 protruding outside the opening 232b is partially embedded within the positioning hole 221a, making the positioning ball 231 be in the locked positioning state, and the antenna mount 210 may be fixed relative to the first side wall 221 under the action of an external force. When the antenna mount 210 drives the positioning ball 231 to disengage from the positioning hole 221a, the positioning ball 231 protruding outside the opening 232b is disengaged from the positioning hole 221a, making the positioning ball 231 be in the unlocked state, and the antenna mount 210 may rotate relative to the first side wall 221 under the action of an external force.

In some embodiments, the plurality of positioning holes 221a may be arranged along a rotation path of the antenna mount 210. In this way, during the process where the positioning ball 231 moves along with the antenna mount 210, a movement path of the positioning ball 231 can match an arrangement path of the positioning holes 221a, thereby improving the reliability and stability of the rotation of the antenna mount 210 relative to the first side wall 221. In addition, the rotation angle of the antenna mount 210 may be determined by two adjacent positioning holes 221a, which thereby helps to adjust and control the rotation angle of the antenna mount 210, and the movement of the positioning ball 231 is relatively smooth, facilitating operation, and the structure is also relatively simple.

In some embodiments, the rotation assembly 200 may further include an elastic positioning component 230. The elastic positioning component 230 may be connected to the antenna mount 210 and located between the antenna mount 210 and the first side wall 221. The elastic positioning component 230 may include a positioning ball 231. The first side wall 221 may be provided with an elongated slot 223, and the elongated slot 223 extends along a rotation path of the antenna mount 210. The elongated slot 223 may include a plurality of positioning sections 224 arranged along the rotation path of the antenna mount 210, and transition sections 225 connecting adjacent ones of the positioning sections 224. The positioning ball 231 may be configured to be selectively in a locked positioning state or an unlocked state. When the positioning ball 231 is in the locked positioning state, the positioning ball 231 is partially located in the positioning section 224. When the positioning ball 231 is in the unlocked state, the positioning ball 231 is partially located in the transition section 225.

When the positioning ball 231 is in the locked positioning state, the positioning ball 231 is partially located in the positioning section 224, which helps the positioning ball 231 to relatively lock the antenna mount 210 relative to the first side wall 221, thereby fixing the antenna mount 210 relative to the first side wall 221. This further helps an operator to debug whether the angle of the antenna mounted on the antenna mount 210 satisfies a use requirement, and subsequently also benefits the operator in fixing the antenna mount 210 relative to the pole connector 220.

When the positioning ball 231 is in the unlocked state, the positioning ball 231 is partially located within the transition section 225, which helps the positioning ball 231 to unlock the antenna mount 210 relative to the first side wall 221, such that the antenna mount 210 may move relative to the pole connector 220 under the action of an external force, which further helps the operator to adjust the angle of the antenna mounted on the antenna mount 210.

In some embodiments, a width L of the transition section 225 is less than a width D of the positioning section 224; and/or, a width L of the transition section 225 gradually decreases in a direction facing away from an adjacent positioning section 224. In this way, under the action of an external force, it is convenient for the positioning ball 231 to move from the positioning section 224 to the transition section 225, thereby making it convenient for the positioning ball 231 to switch from the locked positioning state to the unlocked state. In addition, under the action of an external force, the positioning ball 231 moves from the transition section 225 to the positioning section 224, thereby making it convenient for the positioning ball 231 to switch from the unlocked state to the locked positioning state.

In some embodiments, the second side wall 222 may be provided with a through hole 222a, and the rotation assembly 200 may further include a locking component 240. The locking component 240 may movably extend through the through hole 222a to unlock or lock the antenna mount 210.

There may be a plurality of situations for the locking component 240 to movably extend through the through hole 222a. For example, the locking component 240 may be a locking bar, and a width of the locking bar may be greater than a hole diameter of the through hole 222a, so that the locking bar forms an interference fit with the through hole 222a. When the locking bar abuts against or is inserted into an outer periphery of the antenna mount 210, the locking bar locks the antenna mount 210, thereby restricting the antenna mount 210 from rotating relative to the pole connector 220; when there is a clearance between the locking bar and the outer periphery of the antenna mount 210, the locking bar unlocks the antenna mount 210, thereby facilitating the antenna mount 210 to rotate relative to the pole connector 220 under the action of an external force. For another example, the locking component 240 may be a screw, and the screw may form a threaded fit with the through hole 222a. When the screw abuts against or is inserted into the outer periphery of the antenna mount 210, the locking component 240 locks the antenna mount 210, thereby restricting the antenna mount 210 from rotating relative to the pole connector 220; when there is a clearance between the locking component 240 and the outer periphery of the antenna mount 210, the locking component 240 unlocks the antenna mount 210, thereby facilitating the antenna mount 210 to rotate relative to the pole connector 220 under the action of an external force.

With reference to FIG. 1 through FIG. 4, in some embodiments, a first insertion portion 223 may be disposed at an end of the pole connector 220 facing away from the antenna mount 210. A second insertion portion 101 may be disposed at an end of the pole body 100 connected to the pole connector 220, and the second insertion portion 101 may be configured to mate with the first insertion portion 223 via insertion. Specifically, there may be a plurality of ways for the first insertion portion 223 to mate with the second insertion portion 101 via insertion. The first insertion portion 223 may include an insertion post, and correspondingly, the second insertion portion 101 may include an insertion recess, so that the insertion post of the first insertion portion 223 is inserted into the insertion recess of the second insertion portion 101. Alternatively, the first insertion portion 223 may include an insertion recess, and correspondingly, the second insertion portion 101 may include an insertion post, so that the insertion post of the second insertion portion 101 may be inserted into the insertion recess of the first insertion portion 223. In this way, when the pole connector 220 and the pole body 100 are assembled, they may be assembled by means of insertion, avoiding a relatively large degree of rotation that would occur if a threaded connection were used when assembling the pole connector 220 and the pole body 100. This thereby reduces the risk of the signal wire 300 becoming tangled (the signal wire 300 is relatively long, and the signal wire 300 easily follows the pole connector 220 or the pole body 100 to rotate and become tangled), making the signal wire 300 less prone to damage. The second insertion portion 101 may be located at an end portion of the antenna mounting tube 120 connected to the pole connector 220.

In some embodiments, the first insertion portion 223 may be provided with a plurality of first through holes 223a along a radial direction thereof; that is, the first insertion portion 223 is provided with a plurality of first through holes 223a along its own radial direction. The plurality of first through holes 223a may be arranged along an axial direction of the first insertion portion 223, allowing the first insertion portion 223 to fixedly mate with the second insertion portion 101 via the plurality of first through holes 223a.

The second insertion portion 101 may be provided with a plurality of second through holes 101a along a radial direction thereof; that is, the second insertion portion 101 may be provided with a plurality of second through holes 101a along its own radial direction. The plurality of second through holes 101a may be arranged along an axial direction of the second insertion portion 101, allowing the second insertion portion 101 to fixedly mate with the first insertion portion 223 via the plurality of second through holes 101a.

The plurality of second through holes 101a correspond one-to-one to the plurality of first through holes 223a, thereby helping the antenna pole 10 to extend through the first through holes 223a and the second through holes 101a via a pin, screw, or bolt, so that the first insertion portion 223 and the second insertion portion 101 are locked and fixed. This reduces the risk of the first insertion portion 223 loosening relative to the second insertion portion 101, thereby improving the reliability and stability of the connection between the pole connector 220 and the pole body 100.

In addition, the plurality of second through holes 101a corresponding one-to-one to the plurality of first through holes 223a enables the plurality of second through holes 101a and the plurality of first through holes 223a to have a variety of combination configurations. This helps to adjust the position of a joint between the first insertion portion 223 and the second insertion portion 101, allowing the pole connector 220 to stretch or retract relative to the pole body 100, which further facilitates fine adjustment of the length of the antenna pole 10.

The connector 110 may be configured as being integrally formed, which thereby facilitates improving the strength of the connector 110 and reduces assembly procedures of the antenna pole 10, thus improving the assembly efficiency of the antenna pole 10.

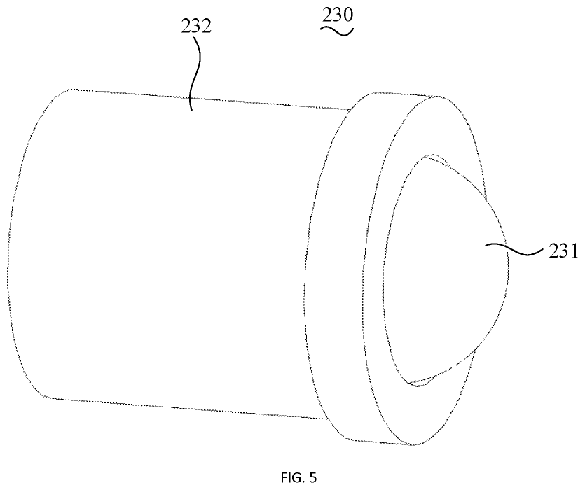

With reference to FIG. 5 and FIG. 7, in some embodiments, the third direction C is perpendicular to the first direction A; that is, an included angle between a length direction of the connecting through-tube 111 extending in the third direction C and a length direction of the connecting through-tube 111 extending in the first direction A is 90 degrees. Specifically, when the antenna pole 10 needs to be mounted on a wall 400 arranged along a vertical direction, at least one antenna mounting tube 120 is connected to the connecting through-tube 111 extending in the first direction A or the second direction B, and at least one antenna mounting tube 120 is connected to the connecting through-tube 111 extending in the third direction C. In this way, the antenna mounting tube 120 connected to the connecting through-tube 111 extending in the first direction A or the second direction B is arranged along a horizontal direction, and the antenna mounting tube 120 connected to the connecting through-tube 111 extending in the third direction C is arranged along the vertical direction. This allows the antenna to be mounted to the antenna mounting tube 120 connected to the connecting through-tube 111 extending in the third direction C, which helps the antenna as a whole to be arranged along the vertical direction, expanding the radiation range of the antenna and facilitating signal transmission and reception by the antenna.

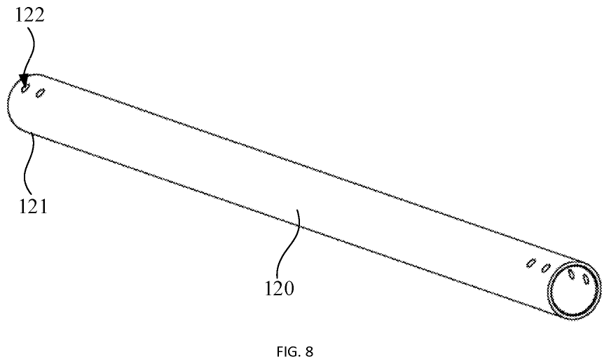

With reference to FIG. 7 and FIG. 8, in some embodiments, a third insertion portion 112 may be disposed at an end of the connecting through-tube 111 connected to the antenna mounting tube 120, and a fourth insertion portion 121 may be disposed at an end portion of the antenna mounting tube 120 connected to the connecting through-tube 111. The fourth insertion portion 121 may be configured to mate with the corresponding third insertion portion 112 via insertion. In this way, when the antenna mounting tube 120 and the connecting through-tube 111 are assembled, they may be assembled by means of insertion, avoiding a relatively large degree of rotation that would occur if a threaded connection were used when assembling the antenna mounting tube 120 and the connector 110. This thereby reduces the risk of the signal wire 300 becoming tangled (the signal wire 300 is relatively long, and the signal wire 300 easily follows the antenna mounting tube 120 or the connector 110 to rotate and become tangled), making the signal wire 300 less prone to damage.

In some embodiments, the third insertion portion 112 may be provided with a third through hole 113, and the fourth insertion portion 121 may be provided with a fourth through hole 122. The fourth through hole 122 may correspond to the third through hole 113. Specifically, after the third insertion portion 112 and the fourth insertion portion 121 are mated via insertion, a pin or a screw may extend through the third through hole 113 and the fourth through hole 122, so that the third insertion portion 112 is fixed relative to the fourth insertion portion 121.

In some embodiments, there may be a plurality of third through holes 113; that is, the third insertion portion 112 is provided with a plurality of third through holes 113 along a radial direction thereof. The plurality of third through holes 113 are arranged along an axial direction of the third insertion portion 112, allowing the connecting through-tube 111 to fixedly mate with the corresponding antenna mounting tube 120 via the third through holes 113. There may be a plurality of fourth through holes 122. The fourth insertion portion 121 may be provided with a plurality of fourth through holes 122 along a radial direction thereof; that is, the fourth insertion portion 121 is provided with a plurality of fourth through holes 122 along its own radial direction. The plurality of fourth through holes 122 are arranged along an axial direction of the fourth insertion portion 121, allowing the antenna mounting tube 120 to fixedly mate with the corresponding connecting through-tube 111 via the fourth through holes 122.

The plurality of fourth through holes 122 corresponding to the plurality of corresponding third through holes 113 means that the plurality of fourth through holes 122 of each antenna mounting tube 120 correspond one-to-one to the plurality of third through holes 113 of the corresponding connecting through-tube 111. Specifically, the plurality of fourth through holes 122 corresponding one-to-one to the plurality of corresponding third through holes 113 helps the antenna pole 10 to extend through the third through holes 113 and the fourth through holes 122 via pins, screws, or bolts, thereby locking and fixing the third insertion portion 112 and the fourth insertion portion 121. This reduces the risk of the third insertion portion 112 loosening relative to the fourth insertion portion 121, thereby improving the reliability and stability of the connection between the antenna mounting tube 120 and the connector 110.

In addition, the plurality of fourth through holes 122 corresponding one-to-one to the plurality of corresponding third through holes 113 enables the plurality of fourth through holes 122 and the plurality of corresponding third through holes 113 to have a variety of combination configurations. This helps to adjust the position of a joint between the third insertion portion 112 and the fourth insertion portion 121, allowing the connecting through-tube 111 to stretch or retract relative to the antenna mounting tube 120, which further facilitates fine adjustment of the length of the antenna pole 10.

With reference to FIG. 7, in some embodiments, each connecting through-tube 111 may be provided with a wire channel 114 along a length direction thereof; that is, each connecting through-tube 111 is provided with a wire channel 114 along its own direction, and any two wire channels 114 are in communication with each other. Specifically, the interior of the antenna mounting tube 120 can accommodate the signal wire 300, and the connecting through-tube 111 of the connector 110 is provided with the wire channel 114. This makes it convenient for the signal wire 300 within two adjacent antenna mounting tubes 120 to extend through the wire channel 114, thereby making it convenient for the signal wire 300 to be installed inside the connector 110, which further facilitates protecting the signal wire 300 and prolongs the service life of the signal wire 300.

Continuing to refer to FIG. 7, in some embodiments, each connecting through-tube 111 is further provided with a wire passage notch 115 in communication with the wire channel 114 along the length direction thereof; that is, each connecting through-tube 111 is further provided with a wire passage notch 115 in communication with its own wire channel 114 along its own length direction, and any two wire passage notches 115 are in communication with each other. Specifically, the signal wire 300 may be installed into the wire channel 114 via the wire passage notch 115, thereby making it convenient for the signal wire 300 to be installed from the wire passage notch 115 into the wire channel 114. The operation is convenient, and the structure is relatively simple.

With reference to FIG. 1 and FIG. 7, in some embodiments, the antenna mounting tube 120 may be sleeved over an outer side of the connecting through-tube 111. In this way, the antenna mounting tube 120 may block the signal wire 300 within the wire channel 114, preventing the signal wire 300 from being exposed out of the wire passage notch 115, and thereby protecting the signal wire 300.

With reference to FIG. 7, in some embodiments, each connecting through-tube 111 may include a plurality of side walls 116. The plurality of side walls 116 of each connecting through-tube 111 may surround and form the wire channel 114, and adjacent ones of the side walls 116 of each connecting through-tube 111 are spaced apart from each other. In this way, the adjacent side walls 116 of each connecting through-tube 111 are spaced apart from each other, thereby facilitating adjustment of a spacing between the adjacent side walls 116 of each connecting through-tube 111. This helps the plurality of side walls 116 to be inserted into the antenna mounting tube 120, and the plurality of side walls 116 may abut against an inner wall of the antenna mounting tube 120, allowing the side walls 116 to be tightly connected with the antenna mounting tube 120. This thereby improves the stability and reliability of the connection between the connecting through-tube 111 and the antenna mounting tube 120. The operation is convenient, and the structure is relatively simple.

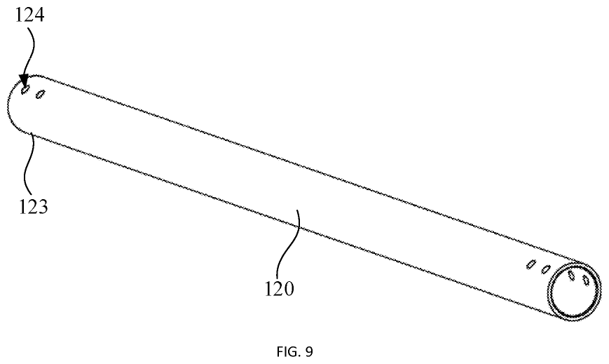

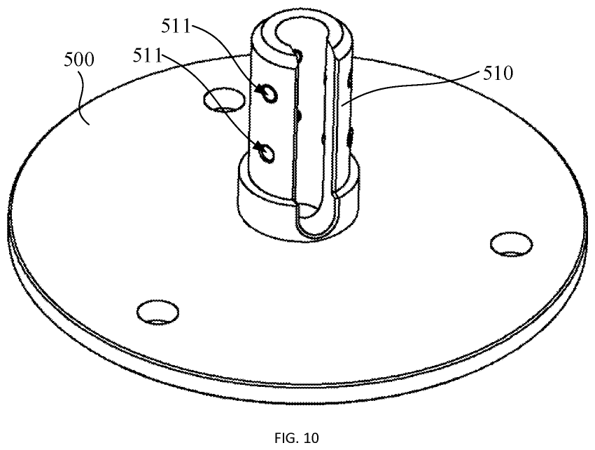

With reference to FIG. 1, FIG. 7, FIG. 9, and FIG. 10, in some embodiments, the antenna pole 10 may further include a base 500. At least one further antenna mounting tube 120 is connected between the connector 110 and the base 500. An end portion of the base 500 connected to the antenna mounting tube 120 may be provided with a fifth insertion portion 510, and an end portion of the antenna mounting tube 120 connected to the base 500 may be provided with a sixth insertion portion 123. The sixth insertion portion 123 may be configured to mate with the fifth insertion portion 510 via insertion. In this way, when the antenna mounting tube 120 and the base 500 are assembled, they may be assembled by means of insertion, avoiding a relatively large degree of rotation that would occur if a threaded connection were used when assembling the base 500 and the antenna mounting tube 120. This thereby reduces the risk of the signal wire 300 becoming tangled, making the signal wire 300 less prone to damage.

In some embodiments, the fifth insertion portion 510 may be provided with a plurality of fifth through holes 511 along a radial direction thereof. The plurality of fifth through holes 511 may be arranged along an axial direction of the fifth insertion portion 510, allowing the base 500 to fixedly mate with the antenna mounting tube 120 via the plurality of fifth through holes 511.

The sixth insertion portion 123 may be provided with a plurality of sixth through holes 124 along a radial direction thereof. The plurality of sixth through holes 124 may be arranged along an axial direction of the sixth insertion portion 123, allowing the antenna mounting tube 120 to fixedly mate with the base 500 via the plurality of sixth through holes 124.

The plurality of sixth through holes 124 corresponding one-to-one to the plurality of fifth through holes 511 means that the plurality of fifth through holes 511 of the base 500 correspond one-to-one to the plurality of sixth through holes 124 of the corresponding antenna mounting tube 120. Specifically, the plurality of sixth through holes 124 corresponding one-to-one to the plurality of fifth through holes 511 enables the antenna pole 10 to extend through the fifth through holes 511 and the sixth through holes 124 via pins or screws, thereby locking and fixing the fifth insertion portion 510 and the sixth insertion portion 123. This reduces the risk of the fifth insertion portion 510 loosening relative to the sixth insertion portion 123, thereby improving the reliability and stability of the connection between the base 500 and the antenna mounting tube 120.

In addition, the plurality of sixth through holes 124 corresponding one-to-one to the plurality of corresponding fifth through holes 511 enables the plurality of sixth through holes 124 and the plurality of corresponding fifth through holes 511 to have a variety of combination configurations. This helps to adjust the position of a joint between the fifth insertion portion 510 and the sixth insertion portion 123, allowing the base 500 to stretch or retract relative to the antenna mounting tube 120, which further facilitates fine adjustment of the length of the antenna pole 10.

In the present application, terms such as “mounted,” “connected,” and the like should be understood in a broad sense, unless explicitly specified or limited otherwise. For example, connections may be a fixed connection, a detachable connection, an integral connection, or a transmission connection; they may be a direct connection, or an indirect connection via an intermediate medium. Those of ordinary skill in the art may understand the specific meanings of the above terms in the present application according to specific circumstances.

In addition, terms such as “first,” “second,” and the like are merely used for descriptive differentiation, and cannot be interpreted as specifically referring to or indicating a special structure. The description with the phrase “some embodiments” implies that a specific feature, structure, material, or characteristic described in connection with the embodiment or example is included in at least one embodiment or example of the present application. In the present application, illustrative expressions of the above terms do not necessarily refer to the same embodiment or example. Moreover, the specific features, structures, materials, or characteristics described may be combined in proper ways in any one or more embodiments or examples. In addition, without mutual contradiction, those skilled in the art can combine and integrate different embodiments or examples described in the present application, as well as the features in different embodiments or examples.

The above embodiments are merely used to illustrate the technical solutions of the present application, and are not intended to limit them. Although the present application has been described in detail with reference to the foregoing embodiments, those of ordinary skill in the art should understand that they can still make modifications to the technical solutions described in the foregoing embodiments, or make equivalent substitutions for some technical features therein. These modifications or substitutions do not make the essence of the corresponding technical solutions depart from the spirit and scope of the technical solutions in the various embodiments of the present application, and should all be included within the protection scope of the present application.

1-20. (canceled)

21. An antenna pole, comprising:
a rotation assembly including an antenna mount and a pole connector, wherein the antenna mount is pivotally connected to the pole connector; and
a pole body, the pole body including a plurality of antenna mounting tubes and a junction fitting, wherein:
the junction fitting includes a plurality of connecting tubes extending in different directions and in communication with each other;
at least one of the plurality of antenna mounting tubes is connected between the pole connector and a first connecting tube of the plurality of connecting tubes; and
at least another one of the plurality of antenna mounting tubes is connected to a second connecting tube of the plurality of connecting tubes.

22. The antenna pole according to claim 21, wherein the pole connector includes a first side wall and a second side wall protruding toward the antenna mount, the second side wall is opposite to and spaced apart from the first side wall, and the antenna mount is pivotally connected between the first side wall and the second side wall.

23. The antenna pole according to claim 22, wherein:
the rotation assembly further includes an elastic positioning component connected to the antenna mount and located between the antenna mount and the first side wall;
the elastic positioning component includes a positioning ball, and the first side wall is provided with a plurality of positioning holes matching the positioning ball;
the positioning ball is configured to be selectively in a locked positioning state or an unlocked state;
when the positioning ball is in the locked positioning state, the positioning ball is partially located in one of the plurality of positioning holes; and
when the positioning ball is in the unlocked state, the positioning ball is disengaged from the plurality of positioning holes.

24. The antenna pole according to claim 23, wherein:
the elastic positioning component further includes a limiting sleeve and a compression spring;
the limiting sleeve defines a limiting space and an opening in communication with the limiting space;
the compression spring is disposed in the limiting space;
a first part of the positioning ball is located in the limiting space and abuts against an end of the compression spring facing the opening; and
a second part of the positioning ball protrudes from the opening.

25. The antenna pole according to claim 23, wherein the plurality of positioning holes are arranged along a rotation path of the antenna mount.

26. The antenna pole according to claim 22, wherein:
the rotation assembly further includes an elastic positioning component connected to the antenna mount and located between the antenna mount and the first side wall;
the elastic positioning component includes a positioning ball;
the first side wall is provided with an elongated slot extending along a rotation path of the antenna mount;
the elongated slot includes a plurality of positioning sections arranged along the rotation path of the antenna mount, and transition sections respectively connecting adjacent ones of the plurality of positioning sections;
the positioning ball is configured to be selectively in a locked positioning state or an unlocked state;
when the positioning ball is in the locked positioning state, the positioning ball is partially located in one of the plurality of positioning sections; and
when the positioning ball is in the unlocked state, the positioning ball is partially located in one of the transition sections.

27. The antenna pole according to claim 26, wherein a width of each of the transition sections is less than a width of each of the positioning sections.

28. The antenna pole according to claim 22, wherein:
the second side wall has a through hole;
the rotation assembly further includes a locking component; and
the locking component movably extends through the through hole to lock or unlock the antenna mount.

29. The antenna pole according to claim 21, wherein:
a first insertion portion is disposed at an end of the pole connector, the end of the pole connector facing away from the antenna mount;
a second insertion portion is disposed at an end of the pole body, the end of the pole body being connected to the pole connector; and
the second insertion portion is configured to mate with the first insertion portion.

30. The antenna pole according to claim 29, wherein:
the first insertion portion has a plurality of first through holes, the plurality of first through holes being arranged along an axial direction of the first insertion portion;
the second insertion portion has a plurality of second through holes, the plurality of second through holes being arranged along an axial direction of the second insertion portion; and
the plurality of second through holes correspond one-to-one to the plurality of first through holes.

31. The antenna pole according to claim 21, wherein:
a third insertion portion is disposed at an end of at least one connecting tube of the plurality of connecting tubes, the end of the at least one connecting tube being connected to a corresponding one of the plurality of antenna mounting tubes;
a fourth insertion portion is disposed at an end of at least one corresponding antenna mounting tube of the plurality of antenna mounting tubes, the end of the at least one corresponding antenna mounting tube being connected to the at least one connecting tube; and
the fourth insertion portion is configured to mate with the third insertion portion.

32. The antenna pole according to claim 31, wherein:
the third insertion portion has a plurality of third through holes extending in a radial direction of the third insertion portion, the plurality of third through holes being arranged along an axial direction of the third insertion portion;
the fourth insertion portion has a plurality of fourth through holes extending in a radial direction of the fourth insertion portion, the plurality of fourth through holes being arranged along an axial direction of the fourth insertion portion; and
the plurality of fourth through holes correspond one-to-one to the plurality of third through holes.

33. The antenna pole according to claim 21, wherein:
the first connecting tube and the second connecting tube each have a wire channel extending along a length direction thereof;
the wire channel of the first connecting tube and the wire channel of the second connecting tube are in communication with each other; and
the first connecting tube and the second connecting tube each further have a wire passage notch in communication with a respective wire channel along the length direction thereof.

34. The antenna pole according to claim 33, wherein at least one of the plurality of antenna mounting tubes is sleeved over an outer side of a corresponding one of the first connecting tube and the second connecting tube.

35. The antenna pole according to claim 33, wherein:
at least one of the first connecting tube and the second connecting tube includes a plurality of side walls;
a respective wire channel of the at least one of the first connecting tube and the second connecting tube is surrounded and defined by the plurality of side walls; and
adjacent ones of the plurality of side walls are spaced apart from each other.

36. The antenna pole according to claim 21, further comprising a base, wherein:
at least one other of the plurality of antenna mounting tubes is connected between the junction fitting and the base;
a fifth insertion portion is disposed at an end of the base connected to the at least one other of the plurality of antenna mounting tubes;
a sixth insertion portion is disposed at an end of the at least one other of the plurality of antenna mounting tubes connected to the base;
the sixth insertion portion is configured to mate with the fifth insertion portion;
the fifth insertion portion has a plurality of fifth through holes extending in a radial direction of the fifth insertion portion, the plurality of fifth through holes being arranged along an axial direction of the fifth insertion portion;
the sixth insertion portion has a plurality of sixth through holes extending in a radial direction of the sixth insertion portion, the plurality of sixth through holes being arranged along an axial direction of the sixth insertion portion; and
the plurality of sixth through holes correspond one-to-one to the plurality of fifth through holes.

37. The antenna pole according to claim 21, wherein:
the plurality of connecting tubes includes three connecting tubes extending respectively in a first direction, a second direction, and a third direction;
the first direction is opposite to the second direction; and
the third direction is at an angle with the first direction.

38. The antenna pole according to claim 37, wherein the first direction is perpendicular to the third direction.

39. A positioning system, comprising:
an antenna pole, the antenna pole including:
a rotation assembly including an antenna mount and a pole connector, wherein the antenna mount is pivotally connected to the pole connector; and
a pole body, the pole body including a plurality of antenna mounting tubes and a junction fitting, wherein:
the junction fitting includes a plurality of connecting tubes extending in different directions and in communication with each other;
at least one of the plurality of antenna mounting tubes is connected between the pole connector and a first connecting tube of the plurality of connecting tubes; and
at least another one of the plurality of antenna mounting tubes is connected to a second connecting tube of the plurality of connecting tubes;
a reference station antenna, wherein the reference station antenna is mounted on the antenna pole; and
a positioning base station, wherein the positioning base station is communicatively connected to the reference station antenna.

40. A yard working system, comprising:
a positioning system, the positioning system including:
an antenna pole, the antenna pole including:
a rotation assembly including an antenna mount and a pole connector, wherein the antenna mount is pivotally connected to the pole connector; and
a pole body, the pole body including a plurality of antenna mounting tubes and a junction fitting, wherein:
the junction fitting includes a plurality of connecting tubes extending in different directions and in communication with each other;
at least one of the plurality of antenna mounting tubes is connected between the pole connector and a first connecting tube of the plurality of connecting tubes; and
at least another one of the plurality of antenna mounting tubes is connected to a second connecting tube of the plurality of connecting tubes;
a reference station antenna, wherein the reference station antenna is mounted on the antenna pole; and
a positioning base station, wherein the positioning base station is communicatively connected to the reference station antenna; and
an autonomous working device, wherein the autonomous working device includes a mobile station antenna being communicatively connected to the positioning base station.
